(19) United States
(12) Patent Application Publication
(10) Pub. No.: US 2018/0267212 A1
(43) Pub. Date: Sep. 20, 2018

(54) EYEGLASS LENS PROTECTOR SYSTEM

(71) Applicant: Ian Contreras, Moorpark, CA (US)

(72) Inventor: Ian Contreras, Moorpark, CA (US)

(21) Appl. No.: 15/925,750

(22) Filed: Mar. 19, 2018

Related U.S. Application Data
(60) Provisional application No. 62/473,118, filed on Mar. 17, 2017.

(51) Int. Cl. G02B 1/14; G02C 11/00

(52) U.S. Cl. CPC G02B 1/14; G02C 11/00

(57) ABSTRACT

An eyeglass lens protector system including a transparent protective film having a first-layer, a second-layer, and a third-layer. The first-layer and the third-layer are removeable from the second-layer. The second-layer is configured to removeably adhere to a lens-surface and provide a protective barrier to protect against smudging, scratching, and breaking of the lens-surface. The transparent protective film may also be applied to electronic device screens or other surfaces.

### CROSS REFERENCE TO RELATED APPLICATION

The present application is related to and claims priority to U.S. Provisional Patent Application No. 62/473,118 filed Mar. 17, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of protective coatings and more specifically relates to a protective film to be applied to a surface.

### 2. Description of Related Art

Eyeglasses or spectacles, are devices consisting of lenses which are mounted in a frame and worn on the bridge of the nose so that the lenses are in front of a person's eyes. Glasses are typically used for vision correction. Eyeglasses are prone to debris and may need to be cleaned several times a day in order for the lenses to remain clear. Eyeglasses are a requirement for some individuals, whether they are near- or far-sighted. The glasses are an expensive investment and must be protected for extensive use. Smudges, scratches, fingerprints, and other inconveniences are common, and people may spend an exorbitant amount of time cleaning their glasses. If the smudges are not removed, visibility may be impaired. A suitable solution is desired.

U.S. Pub. No. 2017/0219742 to Matthew Baker relates to a curved lens protector. The described curved lens protector includes a curved lens protector which can include a transparent body having a self-supporting x-y axis curve with a concave inner surface and a convex outer surface opposite the inner surface. The transparent body can have an outer boundary of a predetermined shape to substantially match and fit with respect to an inner boundary of a lens holder portion of a predetermined lens frame. The transparent body can be configured for attachment to a predetermined curved lens without the use of an adhesive.

### BRIEF SUMMARY OF THE INVENTION

In view of the foregoing disadvantages inherent in the known protective coating art, the present disclosure provides a novel eyeglass lens protector system. The general purpose of the present disclosure, which will be described subsequently in greater detail, is to provide a protective layer which may be applied to screens, glasses and other items to prevent smudging, scratching and breaking.

An eyeglass lens protector system is disclosed herein. The eyeglass lens protector system includes a transparent protective film having a first-layer, a second-layer, and a third-layer. The transparent protective film comprises the first-layer, the-second-layer, and the third-layer in a respective series, together forming a thickness. The first-layer and the third-layer are removeable from the second-layer. The second-layer is configured to removeably adhere to a lens-surface or electronic device screen. The transparent protective film comprises a substantially similar shape as a lens having the lens-surface. The transparent protective film when applied provides a protective barrier to protect against smudging and scratching of the lens-surface.

According to another embodiment, a method of applying the eyeglass lens protector system is also disclosed herein. The method of applying the eyeglass lens protector system includes providing a transparent protective film having a first-layer, a second-layer, and a third-layer; preparing and cleaning a lens-surface; removing a first-half of the third-layer; applying the second-layer to the lens-surface; removing a second-half of the third layer; smoothing the transparent protective film to remove bubbles; removing the first-layer; and removing the transparent protective film from the lens-surface.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an eyeglass lens protector system, constructed and operative according to the teachings of the present disclosure.

FIG. 1 is a perspective view of the eyeglass lens protector system during an ‘in-use’ condition, according to an embodiment of the disclosure.

FIG. 2 is a perspective view of the eyeglass lens protector system of FIG. 1, according to an embodiment of the present disclosure.

FIG. 3 is a perspective view of the eyeglass lens protector system of FIG. 1, according to an embodiment of the present disclosure.

FIG. 4 is a perspective view of the eyeglass lens protector system of FIG. 1, according to an embodiment of the present disclosure.

FIG. 5 is a flow diagram illustrating a method of use for the eyeglass lens protector system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a protective coating and more particularly to an eyeglass lens protector system as used to improve the protection of eyewear.

Generally, the present invention provides eyeglass wearers with a protective covering for their lenses. It prevents fingerprints, scratches, and other damage to eyeglass lenses upon installation. It utilizes a thin, film-like product which adheres directly overtop eyeglass lenses for protection. It installs conveniently on any size, shape, make, and model of eyeglass lenses. The present invention offers a simple-to-install, inexpensive, and convenient method of keeping eyeglass lenses fully protected for an extended period of time. Eyeglass lens protector system may be applied over eyeglass lenses for effective protection from scratches, smudges, and more.

The eyeglass lens protector system comprises of a thin layer of film designed to adhere to virtually any type of eyeglass lenses. The eyeglass lens protector system is intended to be an exact fit for the lens type to prevent any overlapping or accidental removal. Users can simply peel the film from its packaging and apply it directly over the eyeglass lenses. The film should easily adhere to the lenses for a perfect fit. The film can be applied and removed at any time. Upon removal, the film leaves the lenses in perfect, usable condition without worry of impaired visibility. When removed, the film does not leave residue from the adhesive. Eyeglass lens protector system can be constructed using plastic and other suitable materials.

The present invention may be used on cameras, watches, mobile devices, or other screens for protection. In a preferred embodiment, the eyeglass lens protector system preferably comprises a thickness of 0.15 mm, a haze maximum of 1.5%, a hardness of 3H, a light transmittance minimum of 92%, and an adhesion power of 130 g/inch. Other specifications may be used. The HD film may prevent oxidation and corrosion.

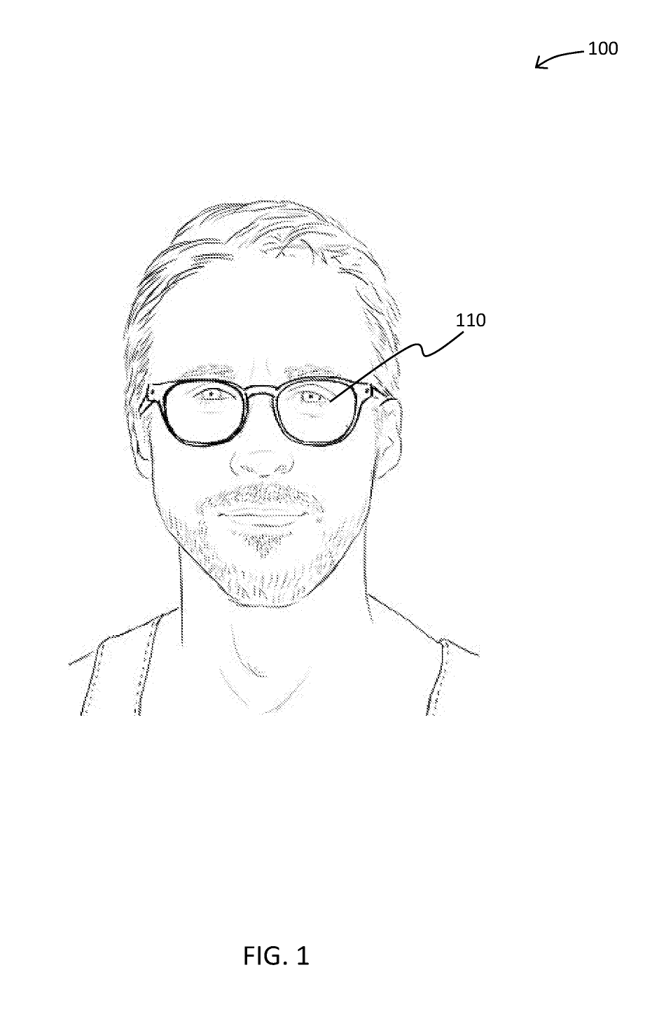

Referring now more specifically to the drawings by numerals of reference, there is shown in FIGS. 1-4, various views of an eyeglass lens protector system 100. FIG. 1 shows an eyeglass lens protector system 100 during an ‘in-use’ condition 150, according to an embodiment of the present disclosure. As illustrated, the eyeglass lens protector system 100 may include a transparent protective film 110 having a first-layer 120, a second-layer 130, and a third-layer 140. The transparent protective film 110 comprises the first-layer 120, the-second-layer 130, and the third-layer 140 in a respective series, together forming a thickness. The first-layer 120 and the third-layer 140 are removeable from the second-layer 130. The second-layer 130 is configured to removeably adhere to a lens-surface 10. The transparent protective film 110 comprises a substantially similar shape as a lens having the lens-surface 10. The transparent protective film 110 when applied provides a protective barrier to protect against smudging and scratching of the lens-surface 10.

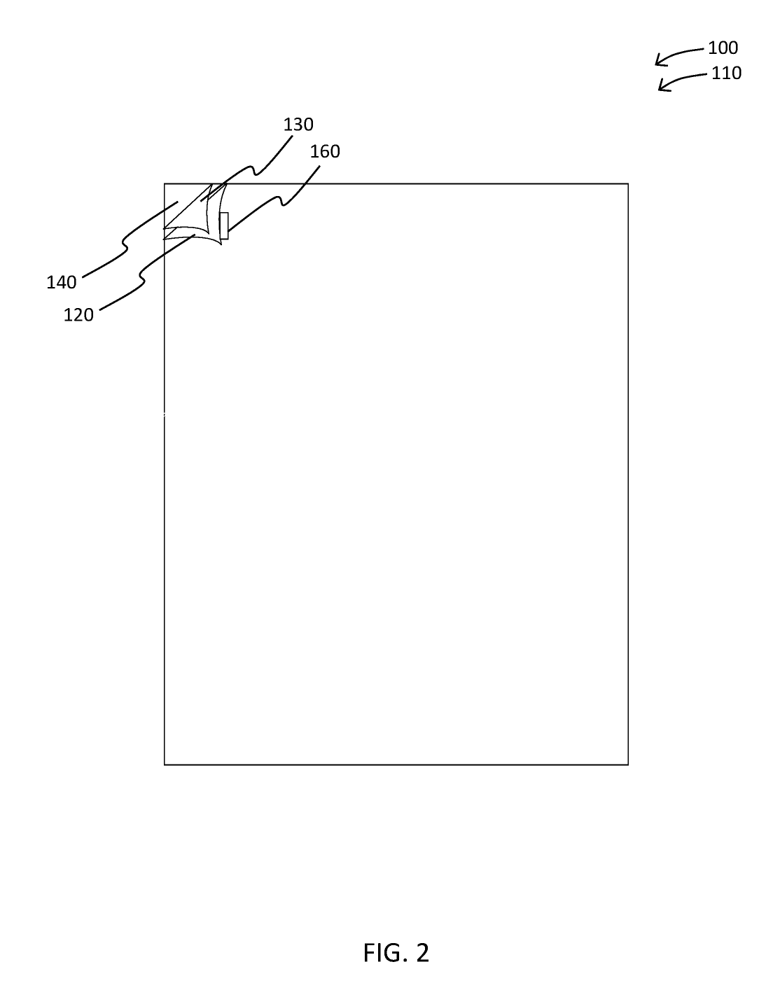

FIG. 2 shows a perspective view of the eyeglass lens protector system 100 of FIG. 1, according to an embodiment of the present disclosure. As above, the eyeglass lens protector system 100 may include the transparent protective film 110 having the first-layer 120, the second-layer 130, and the third-layer 140. The transparent protective film 110 is flexible and configured to contour an outer portion of the lens-surface 10. The lens-surface 10 may be curved or flat. The transparent protective film 110 is further configured to be applied to a screen of a mobile device, camera or other screen. The transparent protective film 110 has an outer boundary extending within and to an inner boundary of a lens-border. The first-layer 120 comprises a yellow PET protective film providing a protective layer. The second-layer 130 comprises a clear TPU film with silicone-adhesive. The third-layer 140 comprises a clear PET release liner.

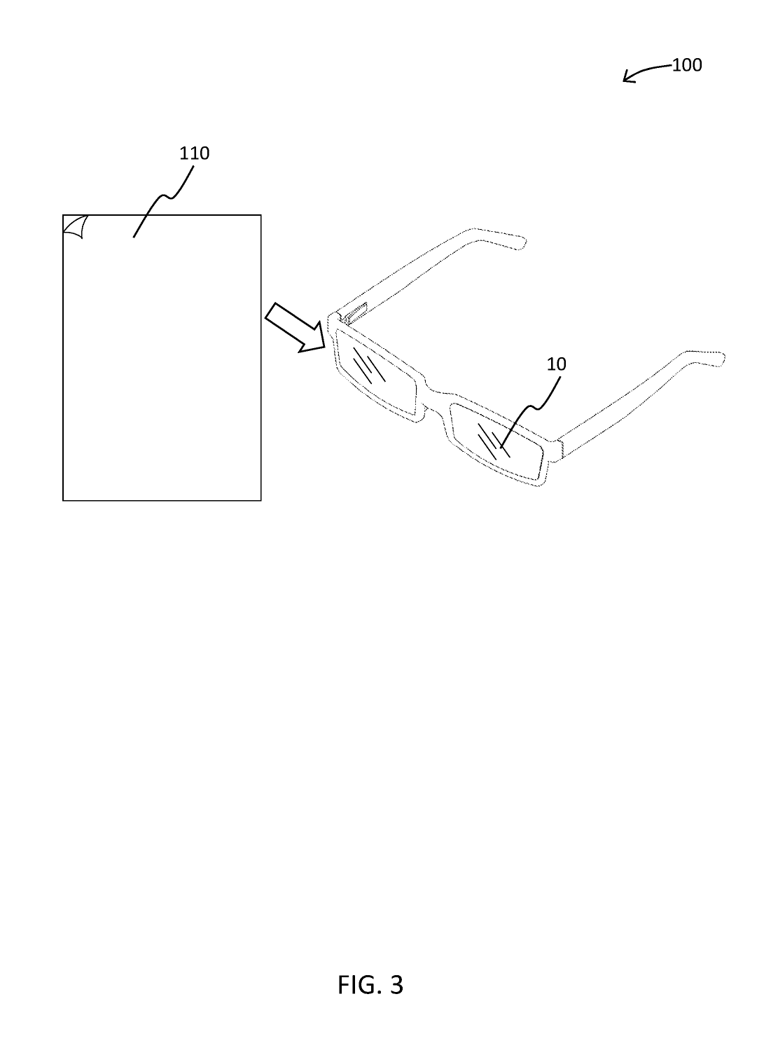

Referring now to FIG. 3 showing a perspective view of the eyeglass lens protector system 100 of FIG. 1, according to an embodiment of the present disclosure. As above, the eyeglass lens protector system 100 may include the transparent protective film 110. The transparent protective film 110 is abrasion and scratch resistant. The transparent protective film 110 comprises a thickness of approximately 0.3 mm. The transparent protective film 110 further comprises a pull tab. The pull tab 160 is on a removeable layer of the transparent protective film 110. The removeable layer is the first-layer 120. The transparent protective film 110 provides a shock resistant layer preventing screen and lens breakage.

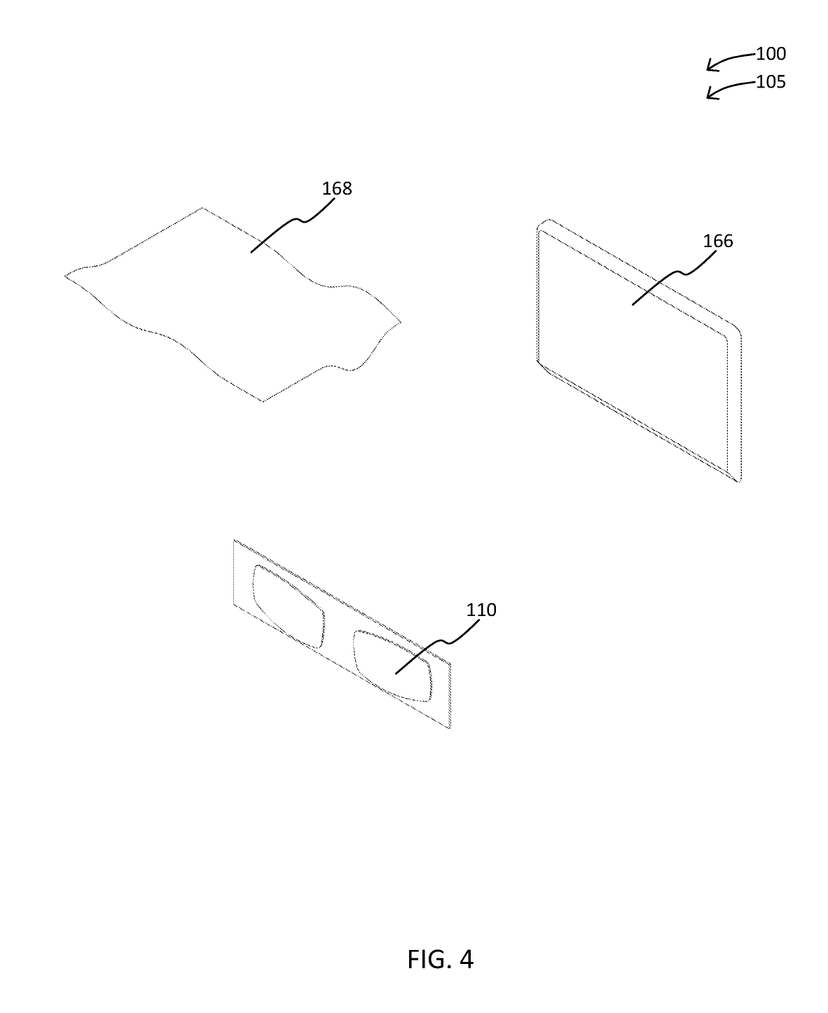

FIG. 4 is a perspective view of the eyeglass lens protector system 100 of FIG. 1, according to an embodiment of the present disclosure. According to one embodiment, the applying eyeglass lens protector system 100 may be arranged as a kit. In particular, the applying eyeglass lens protector system 100 may further include a set of instructions; at least one transparent protective film 110; a smoothing application tool 166; and a cleaning cloth 168. The instructions may detail functional relationships in relation to the structure of the applying eyeglass lens protector system 100 such that the applying eyeglass lens protector system 100 can be used, maintained, or the like, in a preferred manner.

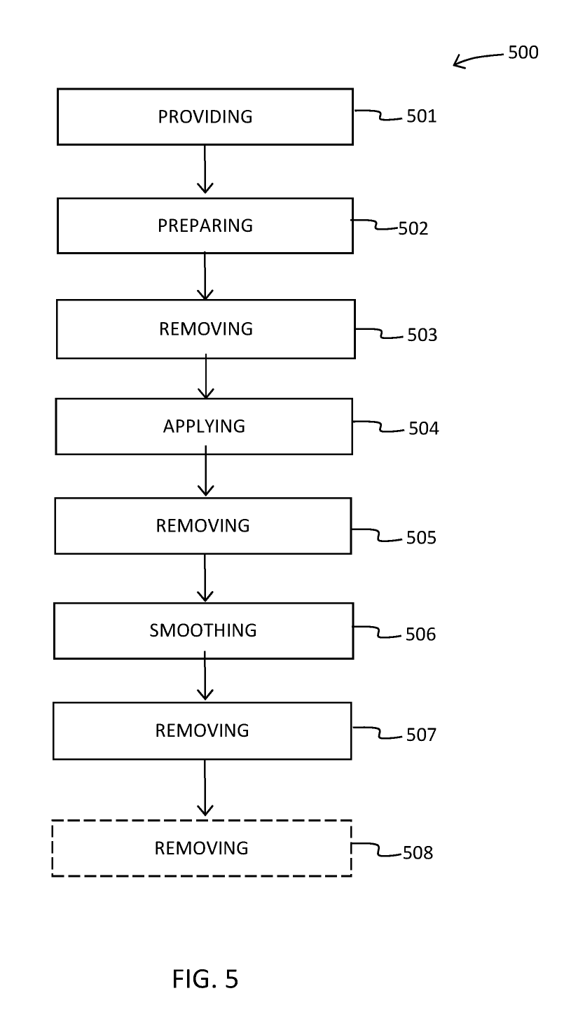

FIG. 5 is a flow diagram illustrating a method for applying eyeglass lens protector system 500, according to an embodiment of the present disclosure. In particular, the method for applying eyeglass lens protector system 500 may include one or more components or features of the eyeglass lens protector system 100 as described above. As illustrated, the method for applying eyeglass lens protector system 500 may include the steps of: step one 501, providing a transparent protective film 110 having a first-layer 120, a second-layer 130, and a third-layer 140; step two 502, preparing and cleaning a lens-surface 10; removing a first-half of the third-layer 140; step three 503, applying the second-layer 130 to the lens-surface; step four 504, removing a second-half of the third layer 140; step five 505, smoothing the transparent protective film 110 to remove bubbles; step six 506, removing the first-layer 120; and step seven 507, removing the transparent protective film 110 from the lens-surface 10.

It should be noted that step seven 507 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for applying eyeglass lens protector system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An eyeglass lens protector system comprising:
a transparent protective film having;
a first-layer;
a second-layer; and
a third-layer;
wherein said transparent protective film comprises said first-layer, said-second-layer, and said third-layer in a respective series, together forming a thickness;
wherein said first-layer and said third-layer are removeable from said second-layer;
wherein said second-layer is configured to removeably adhere to a lens-surface;
wherein said transparent protective film comprises a substantially similar shape as a lens having said lens-surface; and
wherein said transparent protective film when applied provides a protective barrier to protect against smudging and scratching of said lens-surface.

2. The eyeglass lens protector system of claim 1, wherein said transparent protective film is flexible and configured to contour an outer portion of said lens-surface.

3. The eyeglass lens protector system of claim 2, wherein said lens-surface is curved.

4. The eyeglass lens protector system of claim 2, wherein said lens-surface is flat.

5. The eyeglass lens protector system of claim 1, wherein said transparent protective film is further configured to be applied to a screen of a mobile device.

6. The eyeglass lens protector system of claim 1, wherein said transparent protective film has an outer boundary extending within and to an inner boundary of a lens-border.

7. The eyeglass lens protector system of claim 1, wherein said first-layer comprises a PET protective film providing a protective layer.

8. The eyeglass lens protector system of claim 1, wherein said second-layer comprises a clear TPU film with adhesive.

9. The eyeglass lens protector system of claim 8, wherein said adhesive is silicone-adhesive.

10. The eyeglass lens protector system of claim 1, wherein said third-layer comprises a clear PET release liner.

11. The eyeglass lens protector system of claim 1, wherein said transparent protective film is abrasion and scratch resistant.

12. The eyeglass lens protector system of claim 1, wherein said transparent protective film comprises a thickness of approximately 0.3 mm.

13. The eyeglass lens protector system of claim 1, wherein said transparent protective film further comprises a pull tab.

14. The eyeglass lens protector system of claim 13, wherein said pull tab is configured on a removeable layer of said transparent protective film

15. The eyeglass lens protector system of claim 14, wherein said removeable layer is said first-layer.

16. The eyeglass lens protector system of claim 1, wherein said transparent protective film provides a shock resistant layer preventing screen and lens breakage.

17. An eyeglass lens protector system, the eyeglass lens protector system comprising:
a transparent protective film having;
a first-layer;
a second-layer; and
a third-layer;
wherein said transparent protective film comprises said first-layer, said-second-layer, and said third-layer in a respective series, together forming a thickness;
wherein said transparent protective film comprises a thickness of approximately 0.3 mm;
wherein said transparent protective film further comprises a pull tab;
wherein said pull tab is configured on a removeable layer of said transparent protective film;
wherein said first-layer and said third-layer are removeable from said second-layer;
wherein said second-layer is configured to removeably adhere to a lens-surface;
wherein said first-layer comprises a PET protective film providing a protective layer;
wherein said second-layer comprises a clear TPU film with adhesive;
wherein said adhesive is silicone-adhesive;
wherein said third-layer comprises a clear PET release liner;
wherein said transparent protective film comprises a substantially similar shape as a lens having said lens-surface;
wherein said transparent protective film is flexible and configured to contour an outer portion of said lens-surface;
wherein said transparent protective film has an outer boundary extending within and to an inner boundary of a lens-border;
wherein said transparent protective film when applied provides a protective barrier to protect against smudging and scratching of said lens-surface;
wherein said transparent protective film is abrasion and scratch resistant;
wherein said transparent protective film provides a shock resistant layer preventing screen and lens breakage; and
wherein said transparent protective film is further configured to be applied to a screen of a mobile device.

18. The eyeglass lens protector system of claim 17, further comprising:
at least one transparent protective film;
a smoothing application tool;
a cleaning cloth;
a set of instructions; and
wherein the eyeglass lens protector system is arranged as a kit.

19. A method of applying eyeglass lens protector system, the method comprising the steps of:
providing a transparent protective film having;
a first-layer;
a second-layer; and
a third-layer;
preparing and cleaning a lens-surface;
removing a first-half of said third-layer;
applying said second-layer to said lens-surface;
removing a second-half of said third layer;
smoothing said transparent protective film to remove bubbles; and
removing said first-layer.

20. The method of claim 19, further comprising the steps of:
removing said transparent protective film from said lens-surface.
